(19) United States
(12) Patent Application Publication
(10) Pub. No.: US 2009/0283361 A1
(43) Pub. Date: Nov. 19, 2009

(54) MULTI-TOOL LADDER TOP

(75) Inventors: Donald L. GIBSON, Louisville, KY (US); Abraham Gomez Lopez, Nuevo Leon (MX)

Correspondence Address: EGBERT LAW OFFICES, 412 MAIN STREET, 7TH FLOOR, HOUSTON, TX, 77002, US

(73) Assignee: Louisville Ladder Inc., Louisville, KY (US)

(21) Appl. No.: 12/123,436

(22) Filed: May 19, 2008

(51) Int. Cl. E06C 7/00

(52) U.S. Cl. 182/129; 182/230

(57) ABSTRACT

A ladder top has a top panel, a groove formed in the top panel, a first drill hole formed in the top panel adjacent the groove, a second drill hole formed in the top panel, a magnet box formed in the top panel adjacent the groove, and a magnet positioned in the magnet box. The groove extends from the first side of the top panel to the second side of the top panel. The groove has a flat portion and an angular portion. The flat portion has a first portion and a second portion. The angular portion is positioned between the first portion and the second portion of the flat portion. The angular portion has a generally V-shape. The first drill hole and the second drill hole are polygonal in shape.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to ladder tops. More particularly, the present invention relates to ladder tops versatilely made for holding tools. Additionally, the present invention the relates to ladder tops versatilely made for holding wooden beams and lengths of pipe.

2. Description of Related Art Including Information Disclosed Under 37 CFR 1.97 and 37 CFR 1.98.

Ladders are commonly used as a means for elevating persons to a specified height to perform a specified function. Users of ladders climb a series of steps, or rungs to reach a desired height. All ladder are finite in height and have a top step which is the highest step and above which no other step exists. Prior art generally refers to this top step as the ladder top. Ladder tops are generally adapted to fit the ladder body, which consists of the remaining rungs and any legs or rails of the ladder.

As the skill of workers in the painting, construction, maintenance, and pipe trades has increased over the years, so has their need for ladder tops that versatilely accommodate the tools of their trades. Prior art ladders have included ladder tops configured to hold the many different types of tools used in a worker's trade. The tools used in such trades can include paint cans, paint brushes, screwdrivers, hammers, wrenches, drills, and tape dispensers. These tools can sometimes slip around the ladder top and fall off the ladder top, which necessitates that a worker climb off the ladder, retrieve the tool, and climb back on the ladder to complete the project. Thus, there is a need for a ladder top that holds the various tools in place on the ladder top.

Another problem associated with workers in the construction and pipe trades is that sometimes these workers must use a wooden beam or a length of pipe in a repair project while standing on a ladder. Typically, these workers must carry the wooden beam or length of pipe under an arm or in a hand while trying to balance on the ladder. Thus, there is a need for a ladder top that can hold a wooden beam or a length of pipe so that a worker can safely balance on a ladder without having to hold the wooden beam or length of pipe.

Various patents have issued relating to ladder tops for holding various tools thereon. For example, U.S. Pat. No. 5,259,480, issued on Nov. 9, 1983 to Bartnicki et al., discloses a ladder top for a self-supporting ladder. The ladder top has four side walls and a top panel. The top panel has at least four edges corresponding with each side wall. The four edges connect a top panel to a first, second, third and fourth side wall. The third and fourth side walls connect the first and second side walls so as to form a rectangular-shaped ladder top. The third and fourth side walls are adapted to connect to the ladder legs. The top panel and first side wall have slots and holes in them so as to act as trays or surfaces for placing equipment, thus enabling a user to better handle tools and paint cans on a ladder top. The second wall has a hook in which to hang a can of paint.

U.S. Pat. No. 5,358,070, issued on Oct. 25, 1994 to Bartnicki et al., discloses a ladder top similar to that disclosed in the '480 patent except that the second side wall has a hook. The top panel and first side wall of the ladder top have holes and slots to hang and place tools as desired by the user. One of the holes in the top panel is a large hole that uses crossed-support members running along the diagonal of the bottom of the top panel so as to support a can of paint instead of using a hook as in the '480 patent.

U.S. Design Pat. No. D530,025, issued on Oct. 10, 2006 to Patton et al., discloses a ladder top design configured for holding tools. The design includes various sized holes in the top panel and a pan in the top panel. Slots are formed in the front side of the ladder top. A first recess pan is formed in the top panel. A second recess pan is concentrically formed within the first recess pan. A circular hole for holding tools is formed in the center of the first and second recess pans.

U.S. Design Pat. No. D531,322, issued on Oct. 31, 2006 to Patton et al., discloses a design for a ladder top. The top panel has different sized holes for inserting tools therein in the top panel. A rectangular pan is formed in the top panel of the ladder top. A slot is formed in the top panel of the ladder top. Slots are formed in a front side of the ladder top. A first recessed pan having a generally circular shape is formed in the top panel. A second recessed pan is concentrically formed within the first recessed pan in the top panel. A hole is formed in the center of the first recessed pan and the second recessed pan. The back side of the ladder top has an arcuate depression therein extending into the first recessed pan. A hook is located in the arcuate depression of the back side of the ladder top.

U.S. patent application Ser. No. 11/347,613, published on Aug. 9, 2007 to Astor et al., discloses a ladder top for a step ladder. The top panel has a plane having a front and a rear. The plane has a bin with a curved front side adjacent the front of the plane for holding small electrical parts. The plane has at least one screwdriver hole for holding the screwdriver. The plane has a hammer/drill holster slot. The plane has a pliers slot. The plane has a wire strippers slot and a channel locks slots. The ladder top has a conduit holder.

U.S. patent application Ser. No. 11/416,961, published on Aug. 9, 2007 to Astor, discloses a ladder top for a stepladder that includes a plane having a front and a rear. The plane has a bin for holding small parts and has a shape to hole a propane tank adjacent the front of the plane. The plane has at least one screwdriver hole. The plane has a drill holster. The plane has a hammer/pipe wrench hole. The plane has a channel lock slot. The plane has a pipe holder extending along the length of a pipe for holding pipe.

U.S. Pat. No. 7,077,238, issued on Jul. 18, 2006 to Butler et al., discloses a ladder caddy for holding tools, small parts, and the like for a workman on a ladder. The ladder caddy includes four curved cradles for holding the caddy to the ladder, two of the cradles hold consecutive and respective rungs of the ladder when the caddy is mounted in a first position, and two of the cradles hold consecutive and respective rungs of the ladder when the caddy is mounted in a second position, which is inverted and upside down from the first position. The caddy includes a tool holding structure extending outwardly from the ladder at an angle of approximately fifteen degrees offset from perpendicular so that when the caddy is mounted on a leaning ladder the structure extends approximately horizontally. The caddy includes a clamp for clamping to the ladder, integrally formed tool holders, and a variety of accessories that mate with the caddy body.

U.S. Pat. No. 7,114,592, issued on Oct. 3, 2006 to Gibson et al., discloses a magnetic tool holder for a ladder that provides selective positioning of tools to the top step of a ladder. The tool holder is comprised of a planar magnetic material that is substantially rectangular fixedly attached to the top step of the ladder. The magnetic material is positioned on the underside or topside of the top step of the ladder and either fastened thereto by an adhesive compound or threaded fasteners such as nut and bolt.

U.S. Pat. No. 7,000,732, issued on Feb. 21, 2006 to Briggs, discloses a ladder having a top portion that has numerous magnets attached or embedded therein. The magnets surround the sides of the ladder top as well as attached to the underside of the top plate. Tools, fasteners, paint cans, or any other metal items can be secured quickly and safely to the ladder top at any time. Moreover, because the device uses thin, flexible magnets, the ladder top is no bulkier than a normal ladder top.

It is an object of the present invention to provide a ladder top that can accommodate a variety of tools.

It is another object of the present invention to provide to a ladder top that can accommodate tools in the painting, construction, maintenance, and pipe trades.

It is another object of the present invention to provide a ladder top that has holes formed therein that are designed to prevent the rotation of tools therein.

It is another object of the present invention to provide a ladder top that can hold beams of wood.

It is still another object of the present invention to provide a ladder top that can hold a length of pipe.

It is another object of the present invention to provide a ladder top that is suitable for holding accessories of workers in the painting, construction, maintenance and pipe trade.

It is another object of the present invention to provide a ladder top that can magnetically hold tools onto the ladder top.

These and other objects and advantages of the present invention will become apparent from a reading of the attached specification and appended claims.

### BRIEF SUMMARY OF THE INVENTION

The present invention is a ladder top comprising a top panel, a groove formed in the top panel, a first drill hole formed in the top panel adjacent the groove, a second drill hole formed in the top panel, a magnet box formed in the top panel adjacent the groove, and a magnet positioned in the magnet box. The groove has a flat portion and an angular portion. The top panel has a first side and a second side. The groove extends from the first side to the second side of the top panel. The flat portion of the groove has a first portion and a second portion. The angular portion of the groove is positioned between the first portion and the second portion of the flat portion. The angular portion has a generally V-shape.

The first drill hole has a polygonal shape. The polygonal shape of the first drill hole has eight sides. The second drill hole has a polygonal shape. The polygonal shape of the second drill hole has six sides. The ladder top further comprises a first recessed pan having a circular shape, a second recessed pan concentrically positioned in the first recessed pan. The angular portion of the groove extends into the first recessed pan. The first drill hole is formed in a center of the first recessed pan and in a center of the second recessed pan.

The ladder top of the present invention can be used in combination with a ladder having an upper end. The ladder top is affixed over the upper end of the ladder.

### BRIEF DESCRIPTION OF THE SEVERAL VIEWS OF THE DRAWINGS

FIG. 1 shows a perspective view of the ladder top of the present invention.

FIG. 2 shows a side elevational view of the ladder top of the present invention.

FIG. 3 shows a side elevational view of the ladder top of the present invention, with a wooden beam placed in the groove.

FIG. 4 shows a side elevational view of the ladder top of the present invention perspective, with a length of pipe placed in the groove.

FIG. 5 shows a perspective view of a ladder with the ladder top of the present invention.

### DETAILED DESCRIPTION OF THE INVENTION

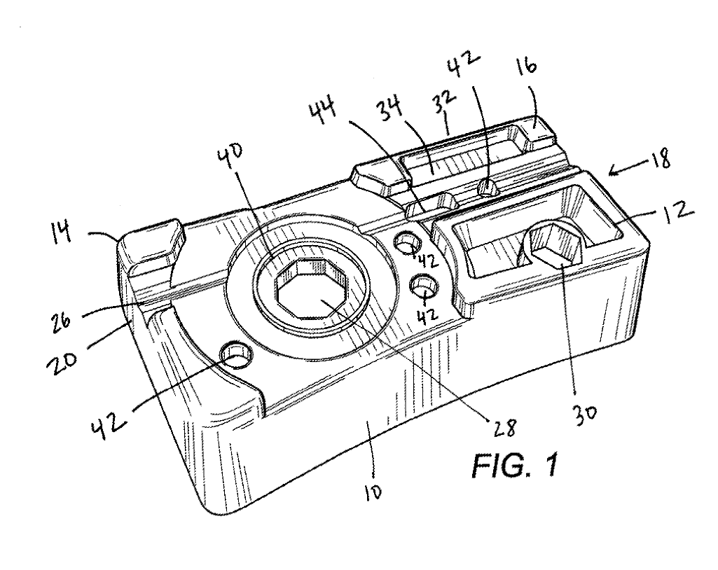

Referring to FIG. 1 there is shown a perspective view of the ladder top 10 of the present invention. The ladder top 10 has a top panel 12. The top panel 12 has a first side 14 and a second side 16. A groove 18 is formed in the top panel 12. The groove 18 extends from the first side 14 to the second side 16 of the top panel 12. The groove 18 has a flat portion 20 and an angular portion 26. As can be seen, the angular portion 26 is located in the middle of the flat portion 20.

A first recessed pan 36 is formed in the top panel 12. The first recessed pan 36 is generally circular in shape. A second recessed pan 38 is concentrically formed in the first recessed pan 36 in the top panel 12. In the ladder top 10 shown in FIG. 1, there is a circular lip 40 located in the second recessed pan 38. The circular lip 40 has a diameter smaller than the diameter of the second recessed pan 38. The first recessed pan 36 is formed so as to support a one-gallon can of paint. The second recessed pan 38 is formed so as to support a half-gallon can of paint. The circular lip 40 has a diameter suitable for supporting cans of aerosol spray. As can be seen, the angular portion 26 of the groove 18 extends into the first recessed pan 36.

Three screwdriver holes 42 are formed in the first recessed pan 36 of the top panel 12. A first drill hole 28 is formed in the center of the first recessed pan 36 and second recessed pan 38. The first drill hole 28 is polygonal in shape. More specifically, the first drill hole 28 has eight sides. A second drill hole 30 is formed in the top panel 12 of the ladder top 10. The second drill hole 30 is polygonal in shape. More specifically, the second drill hole 30 has six sides. The first and second drill holes 28 and 30 are polygonal in shape so as to help prevent the rotation of tools placed therein. For example, a drill placed in either the first drill hole 20 or the second drill hole 30 is less likely to rotate within the holes 28 and 30 because of the polygonal shape of the holes 28 and 30. If the drill holes 28 and 30 were circular in shape, a drill would be much more likely to rotate in the holes 28 and 30, and thus, much more likely to cause problems for the worker on the ladder. The second drill hole 30 is smaller than the first drill hole 28. Thus, the second drill hole 30 has only six sides as opposed to the first drill hole 28, which has eight sides. It has been found that having the first and second drill holes 28 and 30 formed in a polygonal shape creates a better resistance to rotation of tools than does holes that are circular in shape, such as screwdriver holes 42. A tool slot 44 is formed in the top panel 12 of the ladder. The tool slot 44 is oval in shape and can accommodate tools and accessories of a different shape than the tools and accessories placed in screwdriver holes 42 and drill holes 28 and 30.

A magnetic box 32 is formed in the top panel. A magnet 34 is placed in the magnetic box 32. Tools that are made of a magnetic material can be placed on the magnet 34 and held in place by the magnet 34. The magnet 34 is a simple bar magnet. The ladder top 10 is integrally formed of a polymeric material.

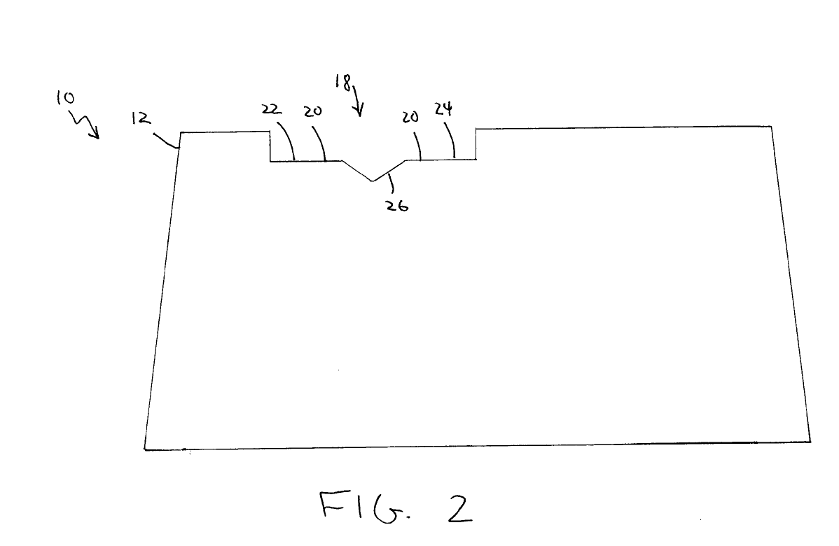

Referring to FIG. 2, there is shown a side elevational view of the ladder top 10 of the present invention. In particular, it can be seen that the groove 18 is formed in the top panel 12. The groove 18 has a flat portion 20 and an angular portion 26. The flat portion 20 has a first portion 22 and a second portion 24. The angular portion 26 is positioned between the first portion 22 and the second portion 24 of the flat portion 20. The angular portion 26 has a generally V-shape. The configuration of the flat portion 20 and the angular portion 26 of the groove 18 allows the ladder top 10 to accommodate both wooden beams and lengths of pipe within the groove 18.

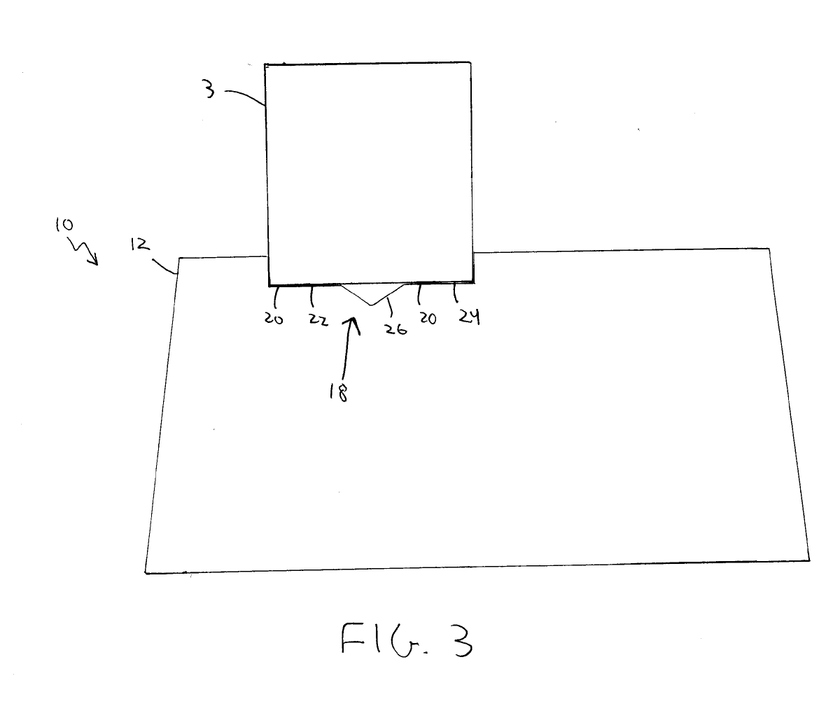

Referring to FIG. 3, there is shown a side elevational view of the ladder top 10 of the present invention, with a wooden beam 3 placed in the groove 18. The flat portion 20 that is formed in the top panel 12 of the ladder top 10 accommodates the wooden beam 3. The wooden beam 3 extends over the angular portion 26 of the groove 18, but does not use the angular portion 26 for support on the ladder top 10. The groove 18 of the ladder top 10 of the present invention is configured so as to hold a 2×4 sized wooden beam.

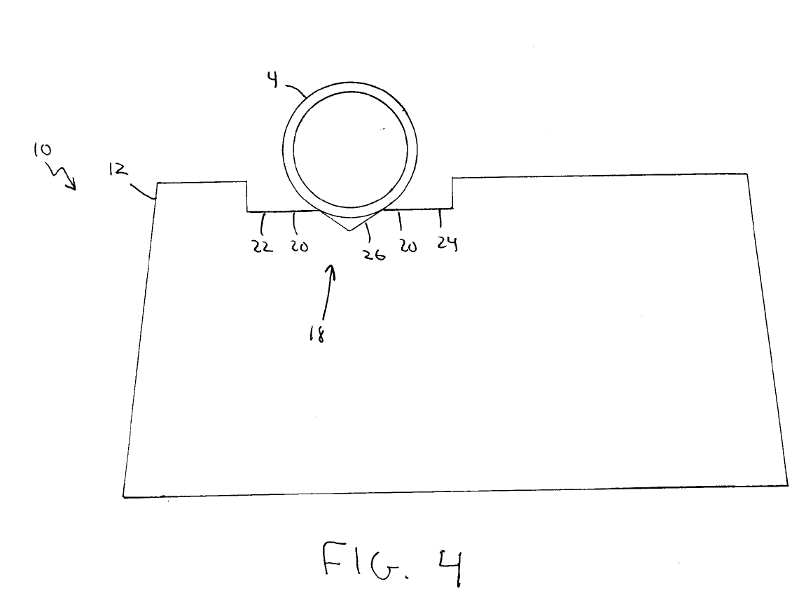

Referring to FIG. 4, there is shown a side elevational view of the ladder top 10 of the present invention, with a length of pipe 4 supported in the groove 18. The length of pipe 4 shown in FIG. 4 is primarily supported by the angular portion 26 of the groove 18. The length of pipe 4 rests against the intersection between the first portion 22 of the flat portion 20 and the angular portion 26 and between the second portion 24 of the flat portion 20 and the angular portion 26. The angular portion 26 is generally in a V-shape. The angle of the angular portion 26 can be of various angles so as to accommodate various sizes of pipe 4. If a larger length of pipe 4 is placed into the groove 18, it is possible that the flat portion 20 would support the pipe 4 and the angular portion 26 would have minimal support of the pipe 4. Regardless, the groove 18 of the ladder top 10 of the present invention can be configured to hold various sizes of lengths of pipe 4.

Referring again to FIGS. 3 and 4, it can be seen that the groove 18 of the ladder top 10 of the present invention is specially configured so as to hold both rectangular wood beams 3 and circular lengths of pipe 4. The location of the angular portion 26 in between the first portion 22 and second portion 24 of the flat portion 20 allows the groove 18 of the ladder top 10 of the present invention to do so.

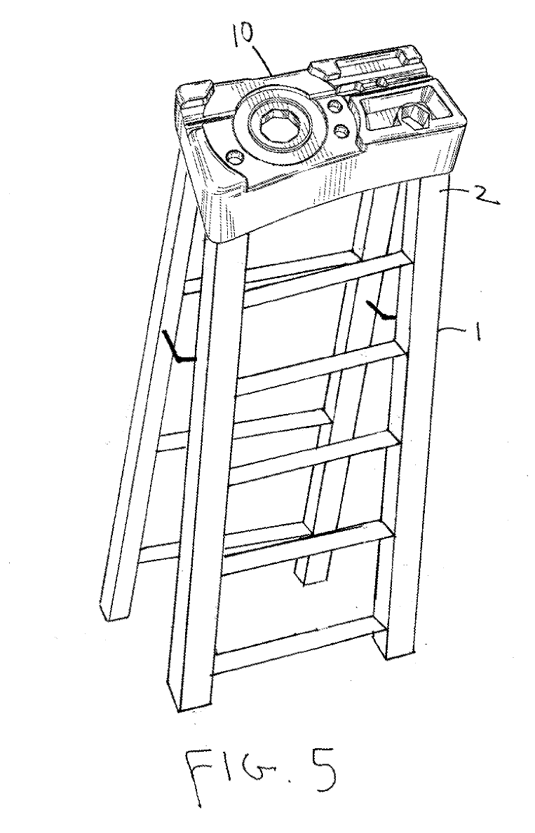

Referring to FIG. 5, there is shown a perspective view of a ladder 1 with the ladder top 10 thereon. The ladder 1 has an upper end 2 on which the ladder top 10 resides. The ladder top 10 makes the ladder 1 versatile for accommodating the various tools and accessories of workers in the painting, construction, maintenance, and pipe trades. The ladder top 10 is exactly the same as the ladder top 10 described in FIGS. 1-4 above.

The foregoing disclosure and description of the invention is illustrative and explanatory thereof. Various changes can be made within the scope of the present claims without departing from the true spirit of the invention. The present invention should only be limited by the following claims and their legal equivalents.

I claim:

1. A ladder top comprising:
a top panel; and
a groove formed in said top panel, said groove having a flat portion and an angular portion.

2. The ladder top of claim 1, further comprising:
a first drill hole formed in said top panel adjacent said groove, said first drill hole having a polygonal shape; and
a second drill hole formed in said top panel, said second drill hole having a polygonal shape.

3. The ladder top of claim 2, further comprising:
a magnet box formed in said top panel adjacent said groove; and
a magnet positioned in said magnet box.

4. The ladder top of claim 1, said top panel having a first side and a second side, said groove extending from said first side to said second side of said top panel.

5. The ladder top of claim 1, said flat portion of said groove having a first portion and a second portion.

6. The ladder top of claim 5, said angular portion of said groove being positioned between said first portion and said second portion, said angular portion having a generally V-shape.

7. The ladder top of claim 2, said polygonal shape of said first drill hole having eight sides.

8. The ladder top of claim 2, said polygonal shape of said second drill hole having six sides.

9. The ladder top of claim 1, further comprising:
a first recessed pan having a circular shape, said angular portion of said groove extending into said first recessed pan; and
a second recessed pan concentrically positioned in said first recessed pan, said top panel having a first drill hole formed in a center of said first recessed pan and in a center of said second recessed pan.

10. An apparatus comprising:
a ladder having an upper end;
a ladder top affixed over said upper end, said ladder top having a top panel; and
a groove formed in said top panel, said groove having a flat portion and an angular portion.

11. The apparatus of claim 10, further comprising:
a first drill hole formed in said top panel adjacent said groove, said first drill hole having a polygonal shape; and
a second drill hole formed in said top panel, said second drill hole having a polygonal shape.

12. The ladder top of claim 11, further comprising:
a magnet box formed in said top panel adjacent said groove; and
a magnet positioned in said magnet box.

13. The ladder top of claim 10, said top panel having a first side and a second side, said groove extending from said first side to said second side of said top panel.

14. The ladder top of claim 10, said flat portion of said groove having a first portion and a second portion.

15. The ladder top of claim 14, said angular portion of said groove being positioned between said first portion and said second portion, said angular portion having a generally V-shape.

16. The ladder top of claim 11, said polygonal shape of said first drill hole having eight sides.

17. The ladder top of claim 11, said polygonal shape of said second drill hole having six sides.

18. The ladder top of claim 10, further comprising:
a first recessed pan having a circular shape, said angular portion of said groove extending into said first recessed pan; and
a second recessed pan concentrically positioned in said first recessed pan, said first drill hole formed in a center of said first recessed pan and in a center of said second recessed pan.
